(19) United States
(12) Patent Application Publication
(10) Pub. No.: US 2015/0278765 A1
(43) Pub. Date: Oct. 1, 2015

(54) INFORMATION COLLECTIONS

(71) Applicant: Microsoft Corporation, Redmond, WA (US)

(72) Inventors: Jagannatha Raju Dantuluri, Sammamish (WA); Marc Christopher Pottier, Seattle, WA (US); Karan Singh, Seattle, WA (US); Deborah Briana Harrison, Seattle, WA (US); David M. Gardner, Covington, WA (US); Shira Weinberg, Herzelia (IL); Michael M. Tse, Kirkland, WA (US); Richa Prasad, Seattle, WA (US); Timothy P. Wantland, Bellevue, WA (US); Shane Landry, Woodinville, WA (US); Susan Michele Hendrich, Redmond, WA (US)

(21) Appl. No.: 14/532,742

(22) Filed: Nov. 4, 2014

Related U.S. Application Data
(60) Provisional application No. 61/973,634, filed on Apr. 1, 2014.

(51) Int. Cl. G06Q 10/10; G06Q 50/00

(52) U.S. Cl. CPC G06Q 10/109; G06Q 50/01

(57) ABSTRACT

A method for displaying an information collection includes collecting a plurality of user signals associated with a user of a device, and identifying a first subject from the plurality of user signals. The first subject has at least a first piece of information. A connection between the first subject and a second subject is determined, and a second piece of information from the second subject is determined. The second piece of information is relevant to the first piece of information. The first and second pieces of information are assembled into a user information collection.

### CROSS REFERENCE TO RELATED APPLICATIONS

This application claims the benefit of U.S. Provisional Application No. 61/973,634, filed Apr. 1, 2014, and titled “Information Collections,” the disclosure of which is hereby incorporated herein by reference.

### BACKGROUND

Multiple sources of information are often accessed for accomplishing day to day tasks. For example, in planning and conducting personal and work activities, a mobile device user may consult multiple calendars, various search applications, social network applications and web sites, and other information applications and web sites (weather, travel, traffic, dining, entertainment, etc.). Upon waking on the departure day for a business trip, for example, a user may check an airline site for flight status, a traffic application to determine travel time to the airport, a weather application to determine weather conditions in the destination city, restaurant reviews for dining ideas in the destination city, etc.

It is with respect to these and other general considerations that embodiments disclosed herein have been made. Also, although relatively specific problems may be discussed, it should be understood that the embodiments should not be limited to solving the specific problems identified in the background or elsewhere in this disclosure.

### SUMMARY

In summary, the disclosure generally relates to user information collections for display on a user device. Such user information collections improve a user's ability to accomplish tasks as opposed to just viewing content. Disclosed methods and systems generally collect a plurality of user signals associated with a user of a device, such as from various applications and or sensors on the user's device. From the signals, a first subject may be identified, wherein the first subject has at least a first piece of potentially relevant information. A connection is then made between the first and another one or more subjects, and a second piece of information from the second subject that is relevant to the first piece of information is identified. The first piece and second pieces of information are assembled into a user information collection that may be displayed for a user on the user device. For instance, flight status, a route between the user's home and the destination airport, traffic conditions, estimated travel times may all be related and relevant information associated with different but connected subjects.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive embodiments are described with reference to the following Figures.

FIG. 1 is a block diagram illustrating an example of a system for displaying a user information collection.

FIG. 2 is a block diagram illustrating an example of a system for creating a user information collection.

FIG. 3 is a block diagram illustrating an example of user information collections associated with various themes.

FIGS. 4A-4D are block diagrams illustrating examples of displayed user information collections.

FIGS. 5A-5D are flow diagrams illustrating examples of methods for creating a user information collection in accordance with aspects of the present disclosure.

FIG. 6 is a block diagram illustrating example physical components of a computing device with which embodiments of the disclosure may be practiced.

FIGS. 7A and 7B are simplified block diagrams of a mobile computing device with which embodiments of the present disclosure may be practiced.

FIG. 8 is a simplified block diagram of a distributed computing system in which embodiments of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

To retrieve and display desired information on a computing device such as a mobile computer, a user often must access several sources. For instance, in planning for a business trip, a user might consult multiple calendars, various search applications, social network applications and sites, and other information applications and sites (weather, travel, traffic, dining, entertainment, etc.). There is typically no one digital place or application (“app”) that gives a user relevant information in a “summary” form.

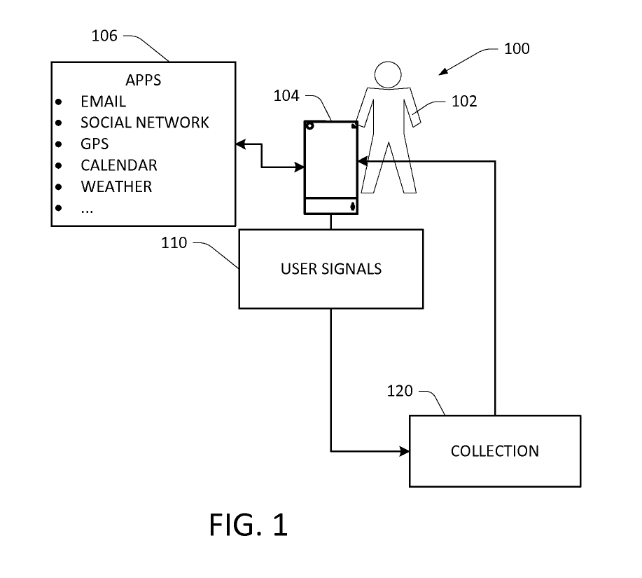

FIG. 1 generally illustrates aspects of an information collection system 100 in accordance with principles of the present disclosure. A user device 104, such as a mobile computer or smart phone, is associated with a user 102. The user device 104 is configured to run a plurality of apps 106, such as one or more email apps, social networking apps, global positioning system (GPS) apps, calendar apps, weather apps, etc. Interaction between the user 102 and the various apps 106 operating on the device 104 generate “signals” 110 associated with the user that contain information in various subjects, which can be collected and analyzed. For example, signals 110 generated by email messages sent and/or received via email apps, social network posts posted and/or read via social network apps, searches submitted via search apps, web sites visited via browser apps, etc. may be evaluated to identify information. Further, signals are not necessarily generated only by overt actions of the user 102. Passive activity or even inaction can generate signals. If the user device 104 is idle for some length of time during some predefined “sleeping” time frame it may be inferred that the user is sleeping, or the location of the device 104 could generate signals without overt interaction between the user 102 and the device 104 and or apps 106 thereon. Selected pieces of information are assembled into a user information collection 120, which can then be displayed on the device 104 for the user 102.

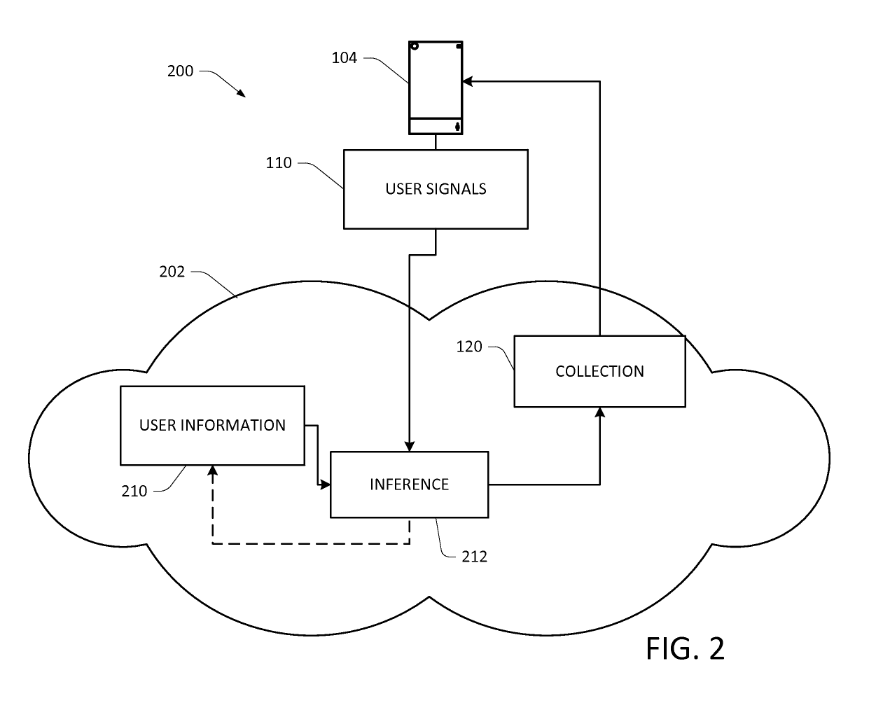

FIG. 2 illustrates an embodiment of a system 200 for creating a user information collection 120 that can be displayed on the device 102. As noted above, user signals 110 are generated by the user's 102 interaction with the device 104 and the apps running thereon. The user signals 110 are received by an inference system 212 that, in the illustrated example, is running on a remote computing system such as a server that is illustrated as running in the “cloud” 202. Although shown as in the cloud 202, those skilled in the art will appreciate that the inference system 212 may run locally or in other environments as well. Moreover, signals 110 could be collected from additional devices associated with the user 102. For example, if the device 104 shown in FIGS. 1 and 2 were a smart phone associated with the user 102, signals could also be collected from the user's desktop computer, laptop, tablet, gaming system, etc.

The inference system 212 receives the user signals 110 and identifies various subjects from the user signals 110 and information associated therewith. In some embodiments, the user device 104 is configured to send signals 110 to the inference system 212 periodically (e.g., at predefined time intervals such as once per hour), and/or when the device 104 is connected to a wife network. The frequency for transmission of signals from the device 104 to the inference system 212 can vary, for instance, based on the type of signals 110 or the apps 106 generating the signals. In some embodiments, predefined rules are established specifying transmission of signals 110 from the device 104 to the inference system 212. For example, each time a calendar entry is made or changed, or each time an email is sent or received, the corresponding signals could immediately be sent to the inference system 212. Other signals 110 could be sent hourly or daily, or sent each time the device 104 is activated.

The inference system 212 further receives user information 210 as an input. For example, user information may be stored in the form of a user profile that includes information about the user 102. In some embodiments, the user information 210 initially includes static, explicit information about the user 102 that may be provided by the user 102, such as by the user 102 filling out a questionnaire. For example, the user profile may include personal information about the user 102 provided by the user, such as gender, age, occupation, interests, club memberships, hobbies, professional associations, etc. User information 210 is used by the inference system 212, along with collected user signals 110, to identify relationships between subjects and associated information to determine relevance of the information for building user collections 120.

User signals 110 may include personally-identifiable information (PII), which may include information users do not want others to know. Some common examples of PII are name, birthdate, SSN, account name, phone number, etc. Other data that may be considered PII includes IP address, company name, and location information. The system 200 allows PII to be protected using, for example, redaction, aggregation, encryption, secure storage, limiting access to individuals with a specific business need for the PII, and other suitable protections. In the interest of privacy a user might choose not to have signals 110 collected, but some users will choose voluntarily to allow such signals 110 to be collected to obtain the benefits of the information collections 120 disclosed herein. Appropriate permission to collect user signals 110 may be obtained from the user in order to preserve the user's interest in privacy.

For instance, if a user is taking a trip including a flight, he or she may need to go to several sites or apps to get necessary or useful information. Desired information could include flight information (e.g., whether the flight is on time), weather in the destination city so the user can pack appropriate clothing, travel time to the departing airport and from the arrival airport (e.g., to determine traffic conditions in the departure and arrival cities), etc. Thus, the user might be required to go to the airline site to get the flight information, consult a weather app for destination city weather forecast, a map app for traffic conditions and directions, among other things.

It is useful to display a collection of relevant information that allows a user to accomplish tasks, rather than simply view content. Determining what information is relevant varies from user to user and also depending on a variety of factors. For instance, certain information is useful upon waking. However, different users wake up and start their days at different times. Further, the specific information relevant to specific users varies based on schedules, interests, location, among other things.

Accordingly, some disclosed examples provided below illustrate ways a user may see personal, contextually correct information at the right time and in a concise manner, rather than simply showing several potentially unrelated data points. This can give the user a “one glance” look at relevant information at appropriate times of the day/week and at appropriate locations. Furthermore, the user can select and influence what he or she wants to see as part of an information collection.

Moreover, information from the inference system 212 may be fed back to the user information 210 to modify the information 210 based on inferences, making the user information 210 dynamic. For example, if the user signals 110 indicate the user 102 has a flight reservation on a given day, the inference system 212 may determine a home location of the user 102 from information provided by the user 102 in the user information 210. Alternatively, the inference system could infer the user's home location based on received signals 110. For instance, if received signals 110 indicate the device 104 is consistently stationary at a given location during the hours of 11 PM to 7 AM, the inference system could be configured to infer the user is sleeping during this time and thus the given location is the user's home location. The inference system may infer the location of the user's departure airport based on signals 110 included in flight reservation information from an airlines app and/or emails. In some embodiments, inferences such as these are confirmed by the user before changing user information 210. Once an inference is confirmed, it may be stored in the user information 210 as a “confirmed inference.” Alternatively, if the inference is not confirmed by the user 102, it may be discarded. Based on these pieces of information, the inference system 212 can then obtain information from various subjects such as flight status, a route between the user's home and the destination airport, traffic conditions, estimated travel times, and assemble this information along with further relevant information into a collection 120 for display on the device 104.

By continuing to monitor user signals 110, the inference system 212 can refine the information collections 120. For example, if location signals indicate the user 102 is typically at a train station prior to flight departures, it can be inferred that the user 102 takes the train to the airport rather than driving. Accordingly, the information collection 120 can be modified to display train departure times on the day of a flight departure. The inference system 212 may also modify the user information 210 to indicate this. Other signals 110 may be used by the inference system 212 to determine relevant information to include in collections 120. If location signals indicate the user is in an area where travelers routinely take taxis to the airport, for example, taxi information could be included in the displayed collection 120 rather than traffic or train information. If collected signals 110 indicate the user typically eats at the airport, this information may be saved in the user information 210, and based on this information the collection 120 also could include information regarding airport restaurants.

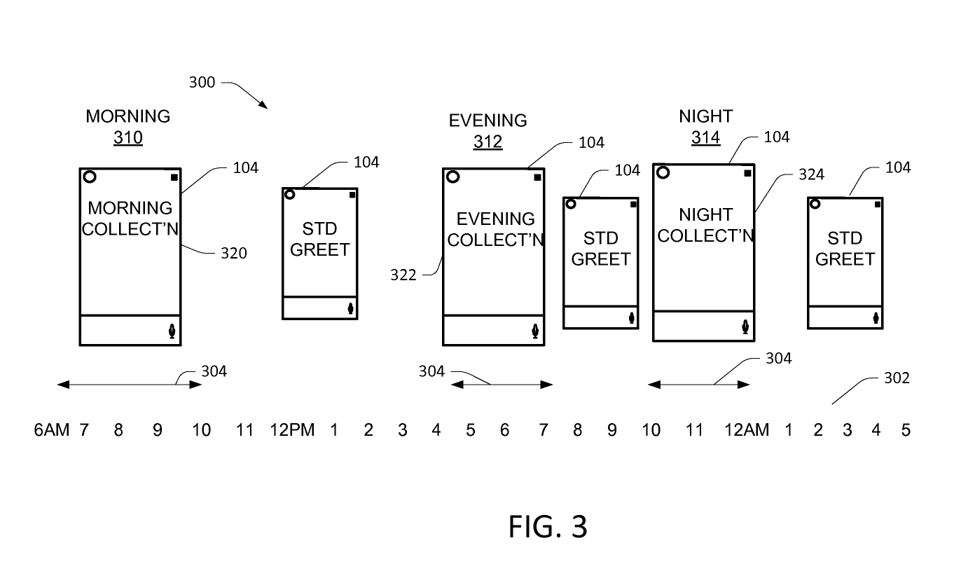

In addition to travel themes such as described above, the user information 210 and inferences 212 based on collected signals 110 may be used to define further themes for the user 102. For example, embodiments of the system 200 use time of day (e.g. the notions of daily prep time, commuting window, evening meal times, etc.) to create themes. Using collected signals 110 and inferences regarding the information included, a “story” is constructed around what the user 102 should see depending on the time and other user circumstances. FIG. 3 illustrates an example of a weekday planner 300, including morning, evening and night themes 310, 312, 314. The user collection 120 displayed on the user device 104 may vary depending on the time of day, the collected signals 110, user information 210 and inferences 212 based thereon. In some implementations, the inference system 212 infers the user's waking time based on user information 210 and/or collected signals 110 such as device start up or unlock, alarms set, device location, etc.

The weekday planner 300 includes a morning theme 310, an evening theme 312 and a night theme 314. A timeline 302 shows example time frames 304 for the themes 310, 312, 314. For example, the inference system 212 may determine that the user 102 leaves for work at 8 AM based on collected signals 110. The morning theme 310 includes a morning collection 320 that is displayed on the device 104 during a time window 304 of two hours before and one hour after the inferred time the user leaves for work. The evening collection 322 is displayed for one hour before and two hours after the user 102 leaves work, and the night collection 324 is displayed for one hour before and one hour after the user's 202 bed time, for example.

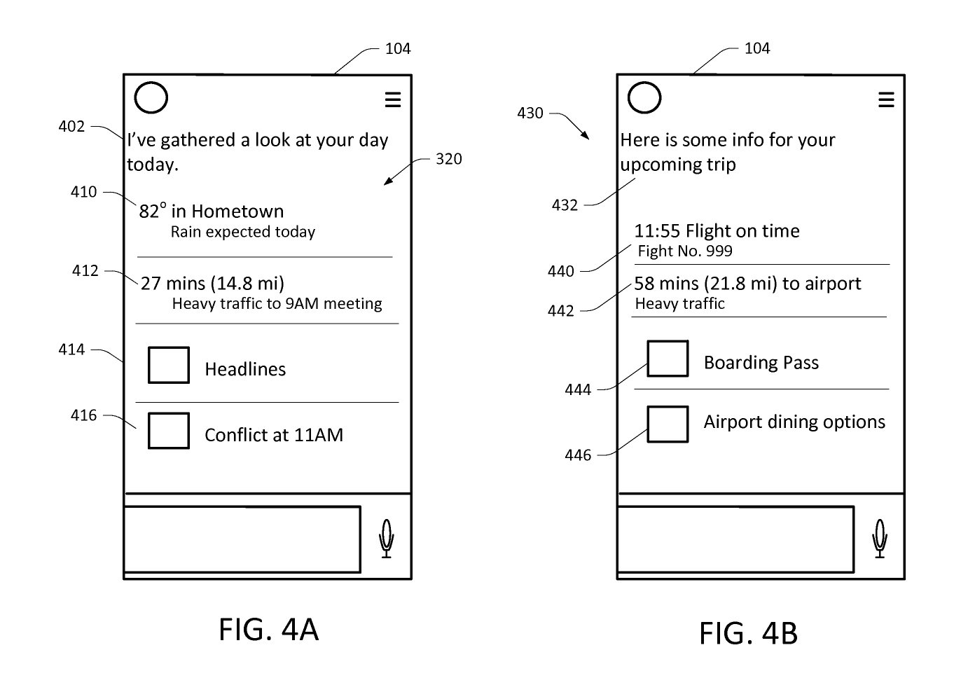

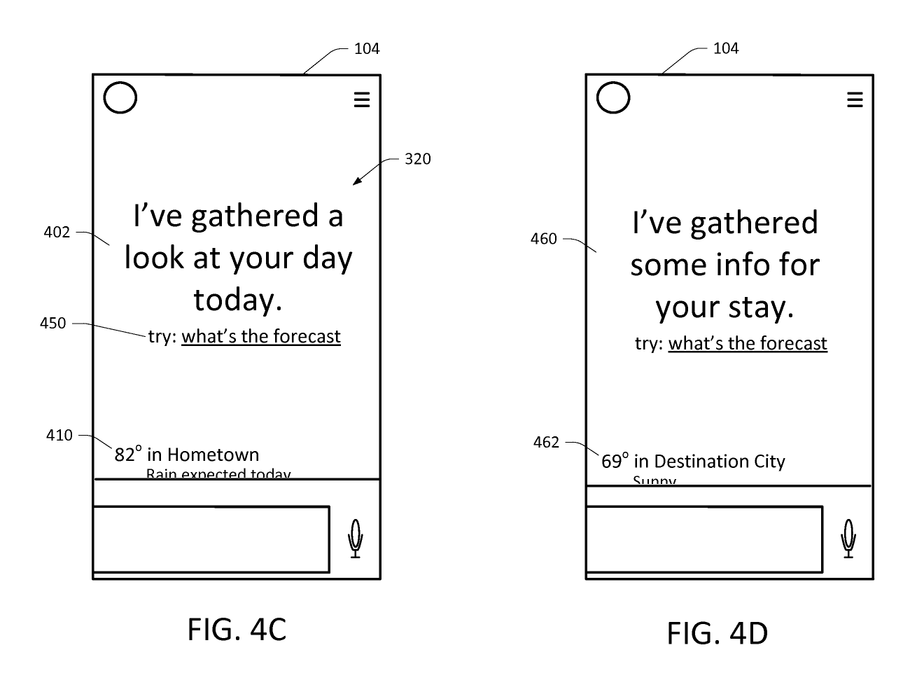

The morning collection 320 may include pieces of information from different subjects that are relevant to one another. As used herein, the term subject generally refers to a category of information. FIG. 4A includes an example of a morning information collection 320. The example, the morning collection could include information in a weather subject 410 (e.g., weather conditions and forecast), a commuting subject 412 (e.g., commute time and time of first appointment), a news subject 414 (e.g., headlines and links to news), a calendar subject 416 (e.g., upcoming calendar conflicts), and the like.

The particular pieces of information included in the information collection 320 are not necessarily static. Initially, the displayed collection 320 could be based on a standard, default collection of information, or it could be based on initial inferences based on collected signals 110. For example, if the user 102 rarely selects the news headlines link in the news information 514, it could be replaced in the collection 320 by another piece of relevant information. If collected signals 110 indicate an interest in a particular stock, for example, an indication of the latest stock value may be included in the user information collection 320 displayed on the device 104 in the morning theme 310.

The example device display shown in FIG. 4A further includes a user greeting 402. The greeting 402 provides a start to the user information collection and can help introduce the content to the user. The example contextual greeting 402 for the morning theme states, “I've gathered a look at your day today,” introducing the user 102 to the displayed morning information collection 320. Referring again to FIG. 3, during times between the morning, evening and night themes 310, 312, 314 a standard greeting 320 may be displayed, such as “Hello! How can I help you?” The morning greeting 302 and standard greeting 320 are illustrated as text on the device 104, though in some embodiments an avatar is included, and/or an audio greeting is played when the user 102 unlocks the device 104, for example. In some implementations, one or both of the standard and contextual greeting is also personalized, such as greeting the user 102 by name.

As the inference system 212 makes further inferences based on collected signals 110, the pieces of information displayed in the user information collections and the greetings presented therewith may be modified to be even more personalized and relevant to the user 102. For example, if the inference system 212 determines that the user 102 regularly watches movies in the evening (based on device context signals, for example), the greeting for the evening display could state, “How about a movie?” The evening information collection 322 could accordingly include a link to movie reviews and/or a movie download service. If the inference system 212 determines that the following day is particularly busy (based on calendar signals, for example), the night greeting could state, “Tomorrow looks like a busy day.” The user information collection could then include information from calendar signals, social network signals, etc. to give the user 102 an overview of his or her day ahead. In some implementations, the greeting and information collection is based on user historical patterns. Instead of simply determining the user 102 has a busy based on some threshold number of appointments, the inference system 212 is configured to evaluate user history regarding appointments, for example, and make a determination whether the indicated future activity is indeed greater than “normal” user patterns. In some embodiments, a plurality of predefined greetings may be stored, and one of the predefined greetings may be selected for display on the user device 104 based on received signals 110, such as time of day, or based on inferences made based on the received signals 110, such as an inferred busy day based on calendar signal trends.

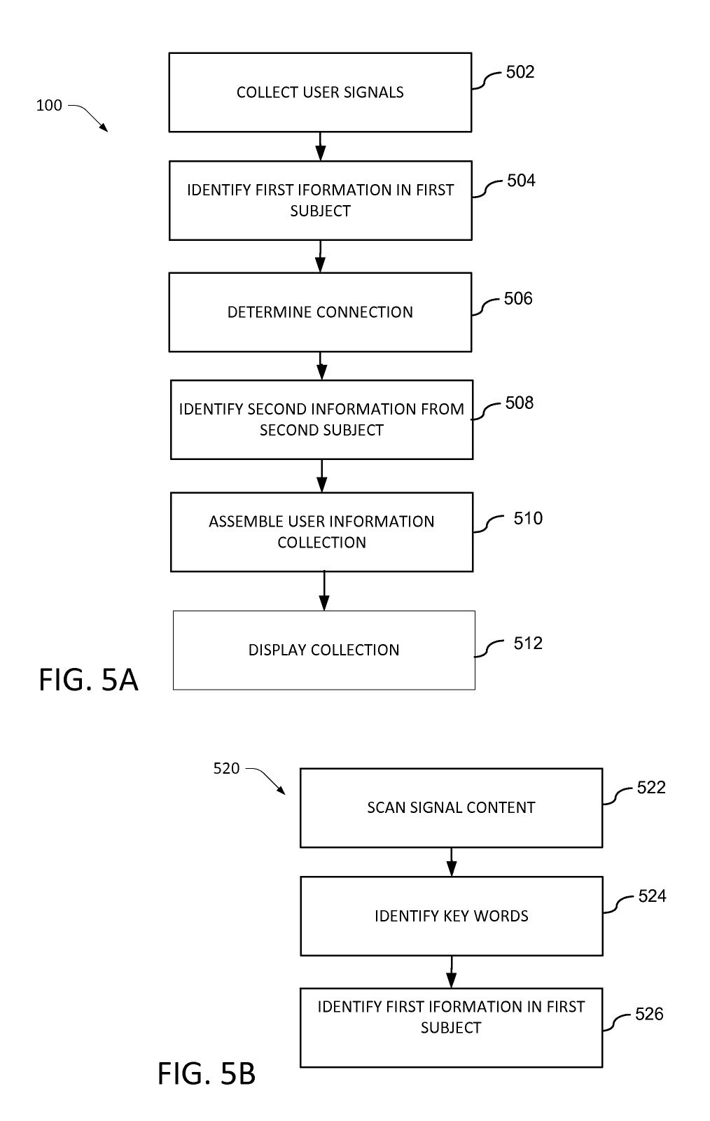

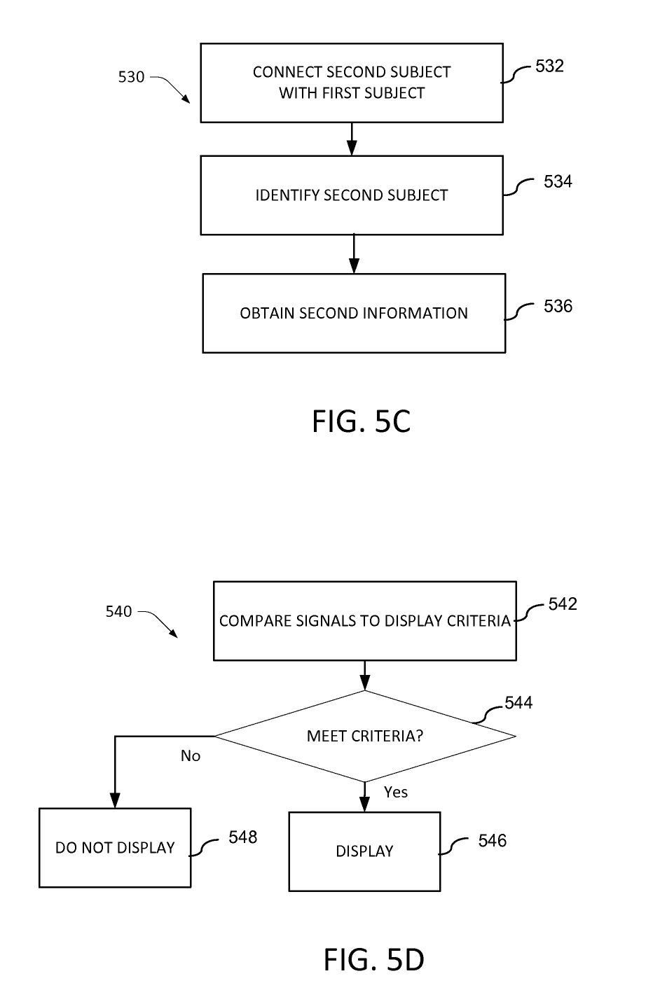

The user collection displayed on the device 104 may be based on signals indicating information other than time of day. For example, FIG. 4B illustrates a user information collection 430 for a flight departure theme. The travel collection 430 could be displayed for a time frame 304 of three hours before a flight departure time, for example. The illustrated travel collection 430 displayed on the device 104 shown in FIG. 5B includes a contextual greeting 432 that states, “Here is some info for your upcoming trip.” The displayed information includes flight time and status 440, travel time to the airport 442, as well as links to view a boarding pass 444 and airport information 446.

Upon landing at the destination, a flight arrival theme may be employed. Based on collected signals 110 (device context signals 212 indicating device location, for example), the inference system 212 determines that the user 102 has landed at the destination and based thereon, displays a user information collection that includes information such as local weather and traffic conditions, a link to rental car and hotel sites, etc. In some examples, a contextualized greeting is further displayed or played, for example, “Welcome to your destination! I've gathered some info for your stay.”

In some embodiments, contextual greetings are displayed without the entire information collection being displayed. FIG. 4C illustrates and example of the device 104 where the user greeting 402 for the morning theme 320 is displayed, with only a “peek” at the user information collection. For example, a single piece of information 410 may displayed, along with an invitation to a suggested link 450 to a web link. If desired, the user 102 can scroll to view the entire morning collection 320. FIG. 4D illustrates an example of a greeting 460 for a travel arrival theme that states, “I've gathered some info for your stay.” Rather than displaying an entire information collection for the travel arrival theme, the greeting 460 is displayed along with a “peek” at the collection, such as weather conditions 462 in the arrival city. The user 102 may scroll to see the entire collection as desired.

FIG. 5 is a flow diagram conceptually illustrating an example of an information collection method 500 in accordance with aspects of the present disclosure. At an operation 502, a plurality of user signals 110 associated with a user 102 of a device 104 are collected. As noted above, signals 110 are generated from user interactions with the apps running on the device 104. As noted above, in some embodiments, signals are sent from the device 104 to the inference system 212 at various times, such as predefined time intervals or when the device 104 is connected to a wife network. For example, emails, social media posts, calendar appointments, GPS location information, etc. may be sent from the device 104 to the inference system 212.

Examples of various user signals 110 associated with a user 102 of a device 104 may include a membership signals (e.g., a gym membership may be used to identify a workout location for the user; a movie club membership may be used to identify a preferred movie theater and/or coupons for the user; etc.), social network signals (e.g., an “I signed up for marathon” post may be used to identify an interest in fitness or running; a “lets meet for dinner” message may be used to identify a preferred dining location or cuisine; etc.), device context signals (e.g., connectivity state and/or location may be used to determine wake or sleep times; user data such as email messages and task lists may be used to determine planned future activities and locations; etc.), real-time data signals (e.g., gym hours; traffic conditions to estimate travel times; a closing of a coffee shop that the user routinely visits on Saturday; etc.), activity data signals (e.g., a preferred stop for coffee before work may be identified based upon device locations of the device 104 corresponding to early morning times; children's after school activities may be identified based upon device locations of the device 104 corresponding to a soccer field at late afternoon times; etc.), calendar signals (e.g., meetings, appointments, etc.).

A first subject including a first piece of relevant information is identified from the plurality of user signals at operation 504. The identified subjects typically include many pieces of information, including relevant information, though for purposes of the illustrated example a first, i.e., relevant, piece of information is considered. FIG. 5B illustrates an example process 520 for identifying subjects. In certain embodiments, the received signals 110 are scanned at operation 522 by the device 104 and/or inference system 212 for predefined key words and/or phrases that indicate relevant information is included in the received signal. In some implementations, the device 104 has rules programmed therein for reviewing signals 110 to determine relevance. In other embodiments, the inference system 212 may identify relevant signals in the received signals 110. The key words and phrases are identified at operation 524, indicating relevant information. Relevant information is grouped into subjects. The key words that identify relevance may, for example, be associated with predefined subjects. Thus, at operation 256, information identified from the identified key words 524 is associated with the proper subject. For example, the device 104 and/or inference system 212 can be configured to scan emails and calendar appointments to identify key words associated with a flight subject, such as airport codes, flight numbers, airline confirmation codes, etc. When these key words are identified, the inference system 212 may infer that the user 102 has booked a flight. The relevant information (e.g., flight number, departure time, airline, etc.) is then associated with the flight subject.

Referring again to FIG. 5A, a connection between the first subject and a second subject is determined at operation 506, and a second piece of information from the second subject is identified at operation 508. As noted herein above, the displayed user collections typically include information from multiple subjects. FIG. 5C illustrates a process for identifying a second piece of relevant information from a second subject. At operation 532, the first subject is connected with a second subject. In some embodiments, the subjects and information to be included in information collections are predetermined and stored in the user information 210 as an information collection “templates” that may be associated with collection themes. Referring back to the user collection 430 for the travel theme, information 440 regarding a flight subject (first subject) is displayed on the device 104. In the example shown in FIG. 4B, the flight subject information 440 displayed includes fight time (11:55), status (on time), flight number (999), etc. The predetermined flight theme collection 430 further includes information from one or more related (“connected”) subjects, such a driving subject (second subject). Information 442 displayed in the collection 430 from the driving subject includes travel time (58 minutes), distance (21.8 miles), and traffic conditions (heavy traffic). Thus, at operation 534, the second subject is identified based on the defined connection with the first subject, and the second information for the second subject is obtained in operation 536.

At operation 510 of FIG. 5A, the first piece of information and the second piece of information are assembled into a user information collection, which may be displayed on the device at operation 512. As noted above, predefined user collection templates may be established and stored in the user information 210. Such predetermined collections, such as the flight theme collection 430 shown in FIG. 4B, may be modified based on received signals 110. As described above, if the signals 110 indicate that the user 102 does not routinely drive to the airport for departing flights, the second subject may be replaced by a more relevant subject (e.g., a “bus” subject if the signals 110 indicate the user 102 routinely takes the bus to the airport). The modified collection template may then be stored in the user information 210. The information collection template, for example, may include various related subjects, as well as desired information from the related subjects to be included in the collection. As these pieces of information are identified (e.g., by analyzing received signals 110), the information is added to the collection template and stored in the user information 210.

FIG. 5D illustrates an example of a process 540 for displaying information collections. Once the information is identified from received signals and assembled into a collection, further signals are compared to display criteria at operation 542. If the criteria are met as determined in operation 544, the collection is displayed at operation 546. If the criteria are not met, the collection is not displayed as indicated at operation 548. The collection may be saved for later display or discarded. Example display criteria include time of day, a time period prior to a scheduled event, location of the user, etc. Referring to the again to the flight theme collection 430 discussed above, the collection 430 could be displayed at some predetermined time or within a predetermined time window prior to the flight departure time. Thus, if signals 110 from the device 104 indicate a time that meets the criteria, the collection 430 is displayed. In some embodiments, the user is asked whether he or she would like to view the collection 430 prior to displaying it. In this case, the display criteria 542 would further include the user's desire to view the display. Additional criteria 542 checked at operation 544 could include the user's location. For instance, if the user is located outside a given distance from the departure airport, the inference system 212 could infer that the flight reservation is not for the user 102, but rather the user 102 has made the reservation for someone else. The signals 110 would therefore indicate that all of the display criteria 542 are not met as determined in operation 544, and the display 430 would not be displayed.

Referring again to the weekday planner 300 illustrated in FIG. 3, the morning collection 320 for the morning theme 310 is displayed during a time window 304 of two hours before and one hour before the user 102 leaves for work. Thus, the display criteria 542 would include such time frame criteria. Additional criteria 542 for displaying the morning collection 320 may include location criteria, such as the user 102 being located at a home location. For instance, if the user 102 activates the device within the appropriate time window 304 defined by the criteria 542, but location signals indicate the user 102 is already located at his or her work location, the criterion is not met at operation 544 and the morning collection 320 would not be displayed as indicated at operation 548. The commute time information, for example, would no longer be relevant to the user 102 if he or she is already at work.

Thus, information identified in different, but connected subjects are assembled into a user information collection. In this manner, a collection of relevant information is presented to the user, rather than simply displaying information.

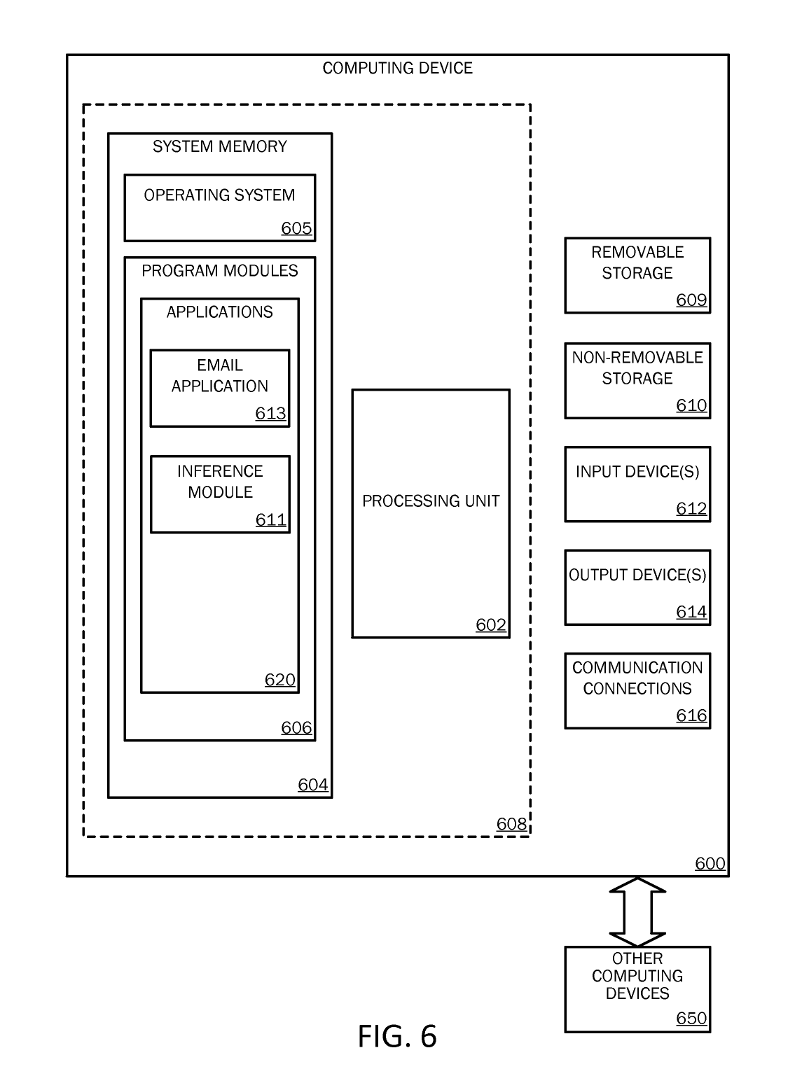

FIGS. 6-9 and the associated descriptions provide a discussion of a variety of operating environments in which embodiments of the disclosure may be practiced. However, the devices and systems illustrated and discussed with respect to FIGS. 6-9 are for purposes of example and illustration and are not limiting of a vast number of computing device configurations that may be utilized for practicing embodiments of the disclosure, described herein

FIG. 6 is a block diagram illustrating physical components (e.g., hardware) of a computing device 600 with which embodiments of the disclosure may be practiced. For example, the inference system 212 shown as operating in the cloud 302 in FIG. 3 could be implemented by the computing device 600. The computing device components described below may include computer executable instructions for an inference module 611 that can be executed to employ the method 100 and implement portions of the system 300 disclosed herein. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running software applications 620 such as the inference module 611. The operating system 605, for example, may be suitable for controlling the operation of the computing device 600. Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610. For example, the user information 210, predefined greetings, default information collections, etc. could be stored on any of the illustrated storage devices.

As stated above, a number of program modules and data files may be stored in the system memory 604. While executing on the processing unit 602, the program modules 606 (e.g., inference module 611 or email application 613) may perform processes including, but not limited to, the information collection system 300 as described herein. Other program modules that may be used in accordance with embodiments of the present disclosure, and in particular to generate screen content, may include electronic mail and contacts applications, word processing applications, spreadsheet applications, database applications, slide presentation applications, drawing, messaging applications, and/or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 618, such as the user device 104. Examples of suitable communication connections 616 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

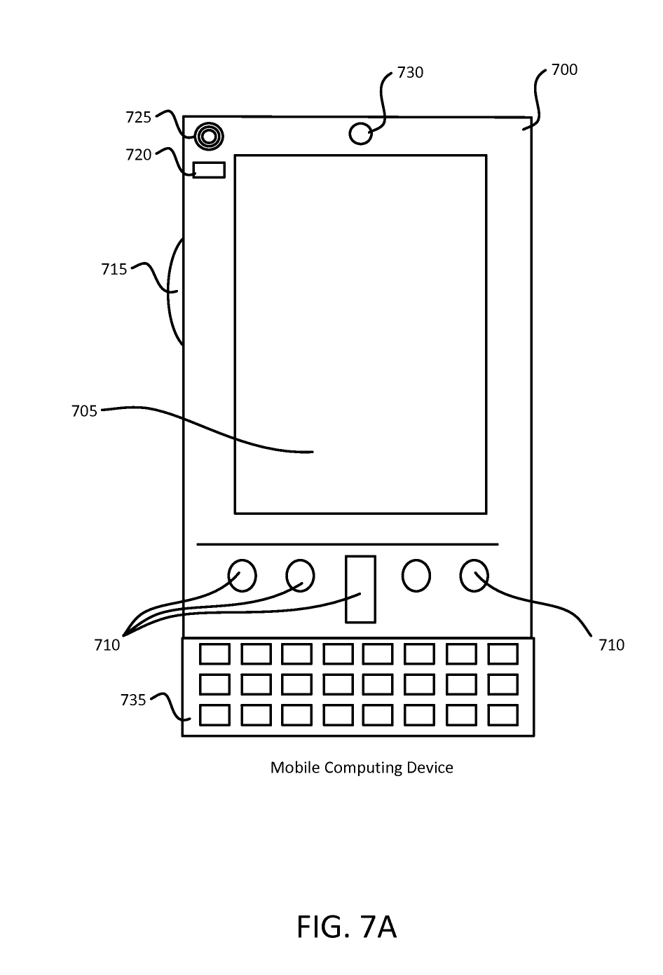

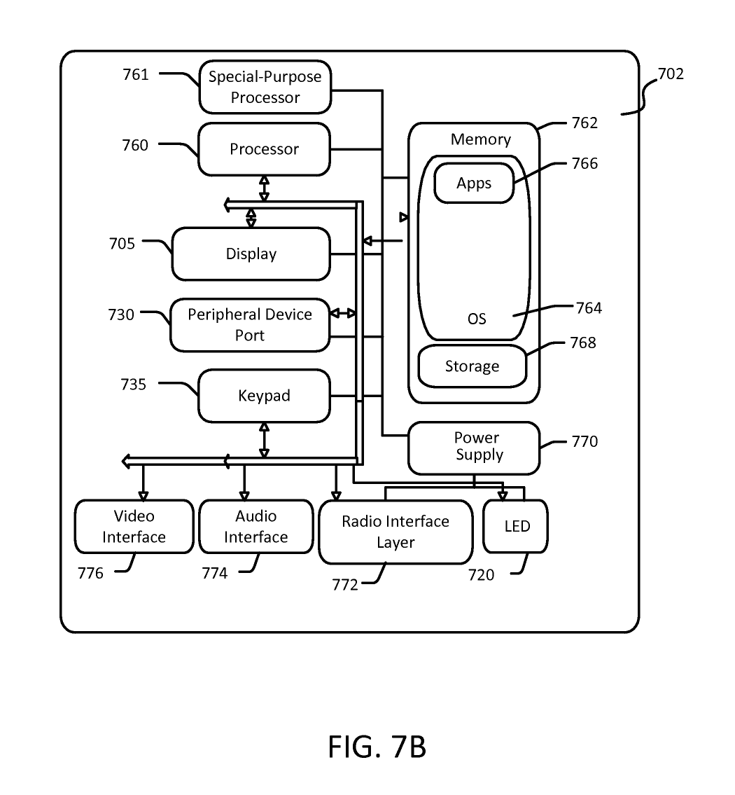

FIGS. 7A and 7B illustrate a mobile computing device 700, for example, a mobile telephone, a smart phone, wearable computer (such as a smart watch), a tablet personal computer, a laptop computer, and the like, with which embodiments of the disclosure may be practiced. For instance, the user device 104 could be implemented by the mobile computing device 700. With reference to FIG. 7A, one embodiment of a mobile computing device 700 suitable for implementing the embodiments is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display).

If included, an optional side input element 715 allows further user input. The side input element 715 may be a rotary switch, a button, or any other type of manual input element. In alternative embodiments, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display.

In addition to, or in place of a touch screen input device associated with the display 705 and/or the keypad 735, a Natural User Interface (NUI) may be incorporated in the mobile computing device 700. As used herein, a NUI includes as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence.

In various embodiments, the output elements include the display 705 for showing a graphical user interface (GUI). In embodiments disclosed herein, the various user information collections could be displayed on the display 705. Further output elements may include a visual indicator 720 (e.g., a light emitting diode), and/or an audio transducer 725 (e.g., a speaker). In some embodiments, the mobile computing device 700 incorporates a vibration transducer for providing the user with tactile feedback. In yet another embodiment, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one embodiment of a mobile computing device. That is, the mobile computing device 700 can incorporate a system (e.g., an architecture) 702 to implement some embodiments. In one embodiment, the system 702 is implemented as a “smart phone” capable of running one or more applications (e.g., browser, e-mail, calendaring, contact managers, messaging clients, games, and media clients/players). In some embodiments, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the instructions to validate a signing certificate in a multi-tenant environment as described herein (e.g., and/or optionally validation module 611).

The system 702 has a power supply 770, which may be implemented as one or more batteries. The power supply 770 might further include an external power source, such as an AC adapter or a powered docking cradle that supplements or recharges the batteries.

The system 702 may also include a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems. User signals 110 may be provided from the user device 104 to the inference system 310 in this manner.

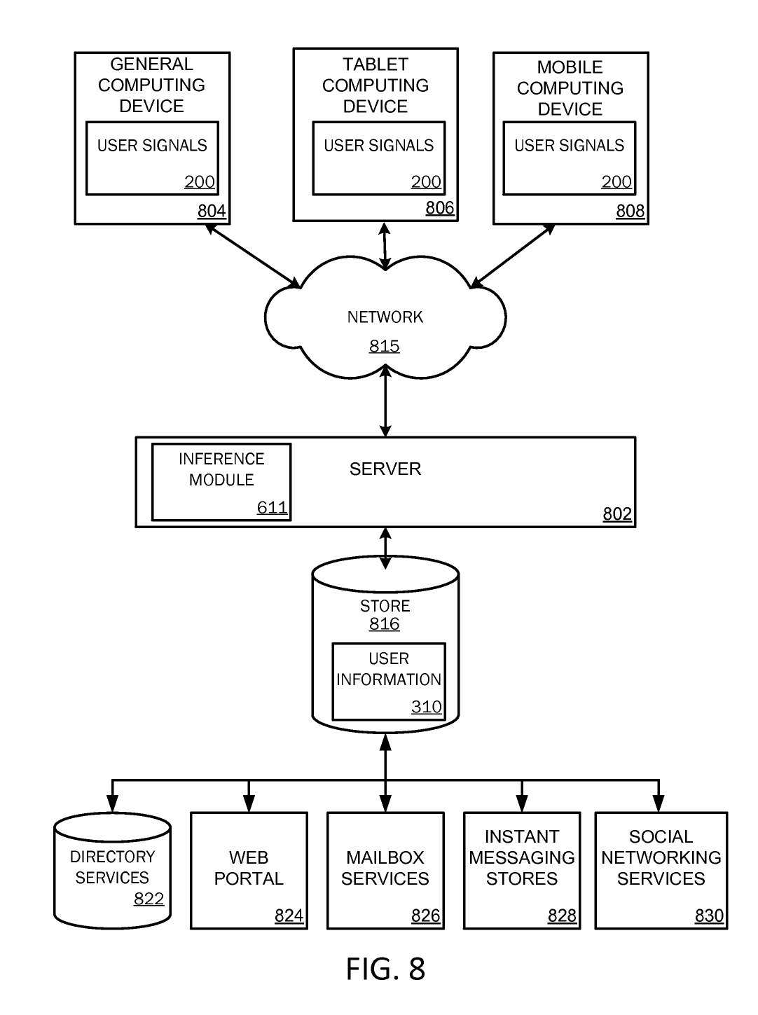

FIG. 8 illustrates one embodiment of the architecture of a system for processing data received at a computing system from a remote source, such as a computing device 804, tablet 806, or mobile device 808, as described above. Content displayed at server device 802 may be stored in different communication channels or other storage types. For example, various documents may be stored using a directory service 822, a web portal 824, a mailbox service 826, an instant messaging store 828, or a social networking site 830. By way of example, the user device 104 may be embodied in a personal computer 804, a tablet computing device 806 and/or a mobile computing device 808 (e.g., a smart phone). User signals 110 may be transmitted to the server 802, which may be configured to implement the inference module 611, via the network 815. In some implementations, user signals 110 are periodically transmitted to the server 802 and are stored in the store 816 along with user information 210.

Among other examples, the present disclosure presents systems and methods for displaying an information collection, comprising: collecting a plurality of user signals associated with a user of a device; identifying a first subject from the plurality of user signals, the first subject comprising a first piece of information; determining a connection between the first subject and a second subject; identifying a second piece of information from the second subject, wherein the second piece of information is relevant to the first piece of information; assembling the first piece of information and the second piece of information into a user information collection; and displaying the user information collection on the device. In further examples, user information is received, and determining the connection includes making an inference based on the user information. In further examples, determining the connection includes making an inference based on the collected signals. In further examples, determining the connection includes considering a time of day. In further examples, the user information collection is modified. In further examples, a default collection is established; and assembling the first piece of information and the second piece of information into the user information collection includes modifying the default collection based on the collected user signals. In further examples, assembling the first piece of information and the second piece of information into a user information collection includes establishing a plurality of themes. In further examples, the themes are based on time of day. In further examples, the themes are based on collected signals. In further examples, a user greeting is displayed contextually related to the user information collection.

Further disclosed aspects provide examples of systems comprising: a computing device including a processing unit and a memory, the processing unit implementing an inference system that is operable to: receive a plurality of user signals associated with a user of a device; make inferences based on the received user signals to identify a first subject from the plurality of user signals, the first subject comprising a first piece of information; determine a connection between the first subject and a second subject; identify a second piece of information from the second subject, wherein the second piece of information is relevant to the first piece of information; and assemble the first piece of information and the second piece of information into a user information collection. In further examples, a mobile device is associated with the user; and the processing unit is operable to transmit the user information collection to the mobile device. In further examples, the memory stores user information, and the inference system is operable to make inferences based on the user information. In further examples, the processing unit is operable to modify the user information stored in the memory based on the inferences. In further examples, the received user signals include time of day signals, and the processing unit is operable to determine the connection between the first subject and the second subject based on the time of day. In further examples, the memory stores a default information collection, and the processing unit is operable to modify the default information collection based on the received user signals. In further examples, the memory stores a plurality of greetings, and the processing device is operable to select one of the greetings based on the user information collection.

Additional aspects disclosed herein provide a computer-readable storage medium including computer-executable instructions stored thereon which, when executed by a computing system in a distributed network, cause the computing system to perform a method comprising: collecting a plurality of user signals associated with a user of a device; identifying a first subject from the plurality of user signals, the first subject comprising at least a first piece of information; determining a connection between the first subject and a second subject; identifying a second piece of information from the second subject, wherein the second piece of information is relevant to the first piece of information; assembling the first piece of information and the second piece of information into a user information collection; displaying the user information collection on the device; and displaying a user greeting contextually related to the user information collection on the device. In further examples, an inference is made based on the collected user signals. In further examples, user information is received, and determining the connection includes making an inference based on the user information.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

This disclosure described some embodiments of the present technology with reference to the accompanying drawings, in which only some of the possible aspects were described. Other aspects can, however, be embodied in many different forms and the specific embodiments disclosed herein should not be construed as limited to the various aspects of the disclosure set forth herein. Rather, these exemplary embodiments were provided so that this disclosure was thorough and complete and fully conveyed the scope of the other possible embodiments to those skilled in the art. For example, aspects of the various embodiments disclosed herein may be modified and/or combined without departing from the scope of this disclosure.

Although specific embodiments were described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

1. A method for displaying an information collection, comprising:
collecting a plurality of user signals associated with a user of a device;
identifying a first subject from the plurality of user signals, the first subject comprising a first piece of information;
determining a connection between the first subject and a second subject;
identifying a second piece of information from the second subject, wherein the second piece of information is relevant to the first piece of information;
assembling the first piece of information and the second piece of information into a user information collection; and
displaying the user information collection on the device.

2. The method of claim 1, further comprising receiving user information, and wherein determining the connection includes making an inference based on the user information.

3. The method of claim 1, wherein determining the connection includes making an inference based on the collected signals.

4. The method of claim 1, wherein determining the connection includes considering a time of day.

5. The method of claim 1, further comprising modifying the user information collection.

6. The method of claim 1, further comprising:
establishing a default collection; and
wherein assembling the first piece of information and the second piece of information into the user information collection includes modifying the default collection based on the collected user signals.

7. The method of claim 1, wherein assembling the first piece of information and the second piece of information into a user information collection includes establishing a plurality of themes.

8. The method of claim 7, wherein the themes are based on time of day.

9. The method of claim 7, wherein the themes are based on collected signals.

10. The method of claim 1, further comprising displaying a user greeting contextually related to the user information collection.

11. A system comprising:
a computing device including a processing unit and a memory, the processing unit implementing an inference system that is operable to:
receive a plurality of user signals associated with a user of a device;
make inferences based on the received user signals to identify a first subject from the plurality of user signals, the first subject comprising a first piece of information;
determine a connection between the first subject and a second subject;
identify a second piece of information from the second subject, wherein the second piece of information is relevant to the first piece of information; and
assemble the first piece of information and the second piece of information into a user information collection.

12. The system of claim 11, further comprising:
a mobile device associated with the user;
wherein the processing unit is operable to transmit the user information collection to the mobile device.

13. The system of claim 11, wherein the memory stores user information, and wherein the inference system is operable to make inferences based on the user information.

14. The system of claim 13, wherein the processing unit is operable to modify the user information stored in the memory based on the inferences.

15. The system of claim 11, wherein the received user signals include time of day signals, and wherein the processing unit is operable to determine the connection between the first subject and the second subject based on the time of day.

16. The system of claim 11, wherein the memory stores a default information collection, and wherein the processing unit is operable to modify the default information collection based on the received user signals.

17. The system of claim 11, wherein the memory stores a plurality of greetings, and wherein the processing device is operable to select one of the greetings based on the user information collection.

18. A computer-readable storage medium including computer-executable instructions stored thereon which, when executed by a computing system in a distributed network, cause the computing system to perform a method comprising:
collecting a plurality of user signals associated with a user of a device;
identifying a first subject from the plurality of user signals, the first subject comprising at least a first piece of information;
determining a connection between the first subject and a second subject;
identifying a second piece of information from the second subject, wherein the second piece of information is relevant to the first piece of information;
assembling the first piece of information and the second piece of information into a user information collection;
displaying the user information collection on the device; and
displaying a user greeting contextually related to the user information collection on the device.

19. The computer-readable storage medium of claim 18, wherein the method further comprises making an inference based on the collected user signals.

20. The computer-readable storage medium of claim 18, wherein the method further comprises receiving user information, and wherein determining the connection includes making an inference based on the user information.
